(19) United States
(12) Patent Application Publication
(10) Pub. No.: US 2018/0317231 A1
(43) Pub. Date: Nov. 1, 2018

(54) Narrowband Carrier Searching

(71) Applicant: Telefonaktiebolaget LM Ericsson (publ), Stockholm (SE)

(72) Inventors: Yi-Pin Eric Wang, Fremont, CA (US); Ansuman Adhikary, Hyderabad (IN); Asbjörn Grövlen, Stockholm (SE); Niklas A. Johansson, Uppsala (SE); Xingqin Lin, San Jose, CA (US); Yutao Sui, Solna (SE)

(21) Appl. No.: 15/765,055

(22) PCT Filed: Sep. 30, 2016
(86) PCT No.: PCT/SE2016/050935

§ 371 Date: Mar. 30, 2018

Related U.S. Application Data
(60) Provisional application No. 62/236,739, filed on Oct. 2, 2015.

(51) Int. Cl. H04W 72/06; H04L 27/00; H04W 72/04

(52) U.S. Cl. CPC H04W 72/06; H04L 27/0006; H04L 5/0007; H04W 72/048; H04W 72/0453

(57) ABSTRACT

A user equipment (400) comprising a narrowband receiver (12) is configured to search among different possible narrowband allocations (16) for a narrowband carrier (14) having a specific characteristic. The narrowband receiver (12) in particular is configured to search a wideband frequency grid for a narrowband portion of a wideband carrier (20) that the narrowband carrier (14) is permitted to lie in-band with or adjacent to, to obtain one or more candidate wideband gridpoints (18). The narrowband receiver (12) prioritizes one or more of the possible narrowband allocations (16) based on their proximity to the one or more candidate wideband gridpoints (18). The narrowband receiver (12) then searches among the different possible narrowband allocations (16) for the narrowband carrier (14) having the specific characteristic, based on the specific characteristic and that prioritization.

### RELATED APPLICATIONS

This application claims priority to U.S. Provisional patent Application Ser. No. 62/236,739 filed Oct. 2, 2015, the entire contents of which are incorporated herein by reference.

### BACKGROUND

Members of the 3^{rd} Generation Partnership Project (3GPP) have agreed to define specifications for what is being called “NB-IoT,” which refers to a “narrowband Internet of things.” These standards will support wireless communications for low-power equipment that may rely on batteries and that will typically send and receive only small amounts of information. Example applications for wireless devices that support NB-IoT include providing parking meters, industrials sensors, and the like with wireless communication capabilities.

The radio interface for NB-IoT will be designed so that a NB-IoT carrier can readily be deployed by operators in or adjacent to portions of their existing wideband spectrum, such as their existing Long Term Evolution (LTE) spectrum. Thus, it is expected that certain aspects of the NB-IoT will be defined to make the most possible use of existing LTE hardware, designs, and procedures. However, changes to the LTE specifications are likely to be made at all levels of the specifications, to reduce power consumption, improve coverage, and otherwise provide for improved operation of low-power wireless equipment. Other deployments are possible, though, including a standalone deployment whereby the NB-IoT carrier is deployed in dedicated spectrum, such as a refarmed GSM band. The type of deployment may not be known a priori to a narrowband receiver searching for a NB-IoT carrier.

In this and other contexts, challenges exist in searching for a narrowband carrier within a frequency spectrum, especially in a low-power and low-cost manner.

### SUMMARY

One or more embodiments herein include a method implemented by a narrowband receiver for searching among different possible narrowband allocations for a narrowband carrier having a specific characteristic. The method comprises searching a wideband frequency grid for a narrowband portion of a wideband carrier that the narrowband carrier is permitted to lie in-band with or adjacent to, to obtain one or more candidate wideband gridpoints. The method also comprises prioritizing one or more of the possible narrowband allocations based on their proximity to the one or more candidate wideband gridpoints. Finally, the method comprises searching among the different possible narrowband allocations for the narrowband carrier having the specific characteristic, based on the specific characteristic and said prioritizing.

One or more embodiments further include a method implemented by a narrowband receiver configured to receive a narrowband carrier having a specific characteristic. The method comprises searching a wideband frequency grid for a wideband carrier that the narrowband carrier is permitted to lie in-band with or adjacent to, by searching the wideband frequency grid for a narrowband center portion of such a wideband carrier. The method also comprises searching among the different possible narrowband allocations for the narrowband carrier having the specific characteristic. The method further comprises upon finding the wideband carrier and the narrowband carrier with the specific characteristic, determining a phase of a wideband reference signal transmitted on the wideband carrier, based on a frequency distance between the center of the narrowband carrier and the center of the wideband carrier that the narrowband carrier is in-band with or adjacent to.

Embodiments also include a method implemented by a narrowband receiver for searching among different possible narrowband allocations for a narrowband carrier having a specific characteristic. The method comprises performing an energy scan across at least some of the different possible narrowband allocations to obtain energy profiles of those allocations. The method also comprises identifying one or more candidate allocations from among the possible narrowband allocations, based on the obtained energy profiles. Finally, the method comprises searching the one or more candidate allocations for the narrowband carrier by searching those one or more candidate allocations for the specific characteristic.

Embodiments herein also include receiver, as well as a radio node (e.g., a base station or a wireless communication device such as a machine-to-machine device) that comprises such a receiver.

Embodiments herein further include a computer program comprising instructions which, when executed by at least one processor of a receiver, causes the receiver to carry out the method as described above.

Embodiments finally include a carrier containing such a computer program. This carrier may be one of an electronic signal, optical signal, radio signal, or computer readable storage medium.

### BRIEF DESCRIPTION OF THE DRAWINGS

FIG. 1 is a block diagram of a radio node that includes a narrowband receiver according to some embodiments.

FIG. 2 is a logic flow diagram of a method performed by a narrowband receiver according to some embodiments.

FIG. 3 is a block diagram of a frequency domain searched by a narrowband receiver according to one or more embodiments.

FIG. 4 is a block diagram of a frequency domain with a narrowband frequency grid that has a finer resolution than a wideband frequency grid according to some embodiments.

FIG. 5 is a block diagram of a frequency domain with a narrowband frequency grid that has a coarser resolution than a wideband frequency grid according to some embodiments.

FIG. 6 is a logic flow diagram of a method performed by a narrowband receiver according to one or more other embodiments.

FIG. 7 is a block diagram of a radio node according to some embodiments.

FIG. 7A is a block diagram of a user equipment according to some embodiments.

FIG. 8 is a block diagram of a base station and wireless device, either or both of which may include a narrowband receiver according to some embodiments.

### DETAILED DESCRIPTION

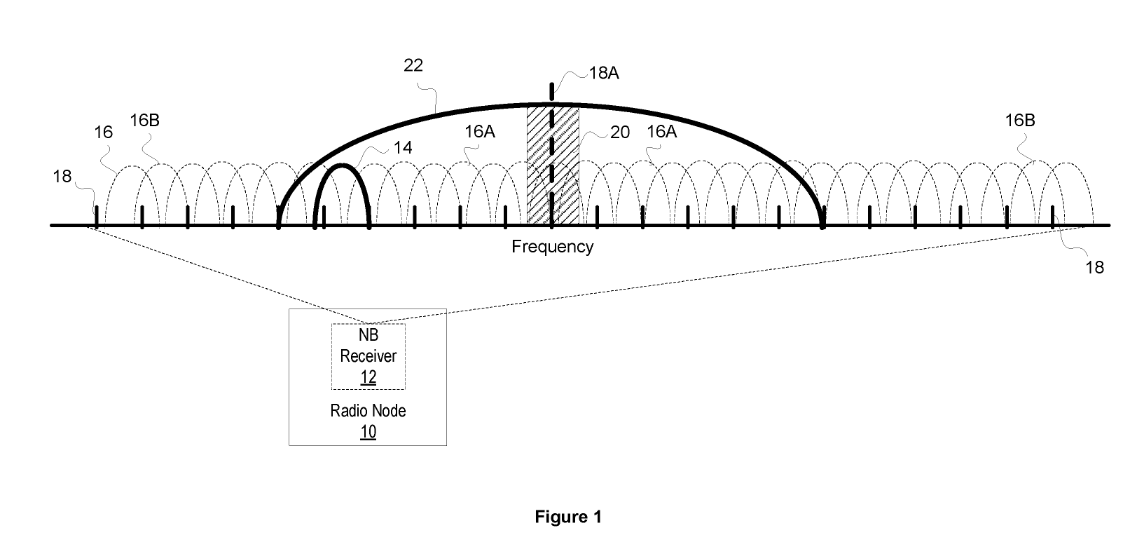

FIG. 1 illustrates a radio node 10 that includes a narrowband receiver 12 (e.g., a narrowband LTE or IoT receiver) configured according to one or more embodiments. The radio node 10 may be a user equipment. The receiver 12 is configured to search the frequency domain for a narrowband carrier 14 having a specific characteristic (e.g., one of different possible synchronization signal sequences). There are multiple different possible narrowband allocations 16 in the frequency domain where the narrowband carrier 16 could be allocated. For example, in some embodiments where the receiver 12 is a narrowband LTE or IoT receiver, the different possible narrowband allocations 16 are approximately 180 kHz frequency allocations (corresponding to one LTE physical resource block) spaced along the frequency domain (e.g., in a grid) every 20 kHz. Challenges exist in searching these different possible narrowband allocations 16 for a narrowband carrier 14, especially in a low-power and low-cost manner.

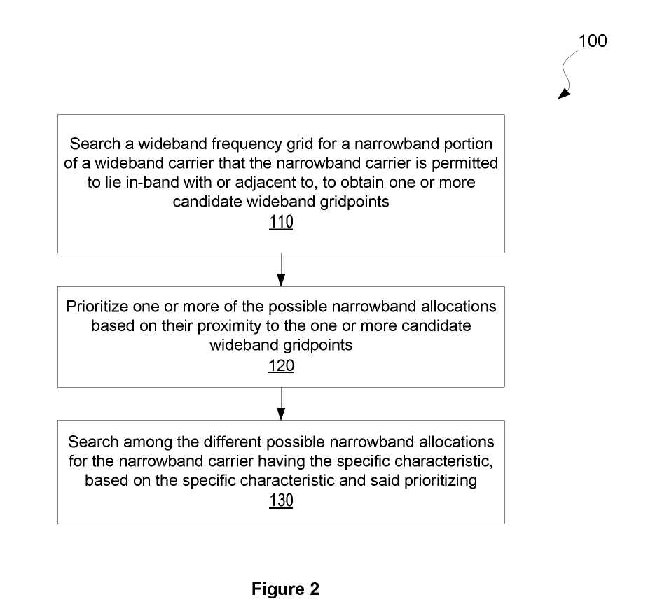

FIG. 2 illustrates processing 100 performed by the receiver 12 for searching among the different possible narrowband allocations 16 for a narrowband carrier according to some embodiments. As shown, the receiver 12 searches a wideband frequency grid 18 for a narrowband portion 20 of a wideband carrier 22 that the narrowband carrier 16 is permitted to lie in-band with or adjacent to, to obtain one or more candidate wideband gridpoints 18A (Block 110). The receiver 12 prioritizes one or more of the possible narrowband allocations 16 based on their proximity to the one or more candidate wideband gridpoints 18 (Block 120). For instance, the receiver 12 may prioritize at least some of the possible narrowband allocations differently based on those allocations having different proximities to the one or more candidate wideband gridpoints. For example, the receiver 12 may rank one or more of the possible narrowband allocations 16 in a priority order, with allocations more likely to include the narrowband carrier 14 ranked with a higher priority than allocations less likely to include the narrowband carrier 14. Regardless, the receiver 12 then searches among the different possible narrowband allocations 16 for the narrowband carrier 14 having the specific characteristic, based on the specific characteristic and the prioritization (Block 130). In some embodiments, for example, the receiver 12 searches the narrowband allocations 16 in a priority order, based on the proximity of those allocations to the one or more candidate gridpoints 18, e.g., so as to search at least some allocations that are closer in proximity to a candidate wideband gridpoint before searching at least some other allocations that are farther away in proximity to a candidate wideband gridpoint.

In one or more embodiments, the narrowband portion of a wideband carrier 22 for which the receiver searches is simply any portion of the wideband carrier, whether located in the center or otherwise of the carrier. The wideband search therefore effectively amounts to a coarse search for the existence of a wideband carrier. The receiver 12 may for instance search for any narrowband portion that has an energy profile characteristic of such a wideband carrier (e.g., by spotting LTE physical resource blocks that stand out from an energy perspective, e.g., due to PRB boosting). Regardless, exploiting the possibility that the narrowband carrier is deployed inband or adjacent to such a wideband carrier, the receiver 12 focuses its search around the general location of where a portion of a wideband carrier is found. The receiver 12 may for instance prioritize narrowband allocations located close to the general location of where a wideband carrier is found.

By contrast, in the one or more embodiments shown in FIG. 1, the narrowband portion 20 of a wideband carrier 22 for which the receiver searches is the wideband carrier's center portion 20. In at least some embodiments, for example, the receiver 12 identifies the wideband carrier's center portion 20 based on the wideband carrier 22 having a known energy signature or profile at its center. In one embodiment, for instance, the receiver 12 searches for a narrowband center portion 20 that has a null at its center (i.e., a DC or null frequency or subcarrier).

Regardless, in such embodiments where the receiver searches for the wideband carrier's center portion 20, a wideband carrier's center frequency is aligned to one of the wideband gridpoints of the wideband frequency grid. For example, where the wideband carrier 20 is a carrier of an LTE system or a system that evolves from LTE, the wideband gridpoints of the receiver's wideband search grid 18 are spaced approximately 100 kHz apart and each LTE carrier is centered on one of these gridpoints. The one or more candidate wideband gridpoints 18A that the receiver 12 identifies in these embodiments are candidates for the center of such a wideband carrier 20. Accordingly, the receiver 12 effectively prioritizes one or more of the possible narrowband allocations 16 based on their proximity to a candidate for the center frequency of a wideband carrier that the narrowband carrier is permitted to lie in-band with or adjacent to. The receiver 12 may for instance prioritize searching at least some narrowband allocations 16A that are closer in proximity to a candidate for the wideband carrier's center 18A before searching at least some other narrowband allocations 16B that are farther away in proximity to a candidate for the wideband carrier's center 18A. In at least one embodiment, the receiver 12 searches contiguous or non-contiguous narrowband allocations 16 surrounding the candidate for the wideband carrier's center 18A in a priority order that emanates outwardly from that center 18A.

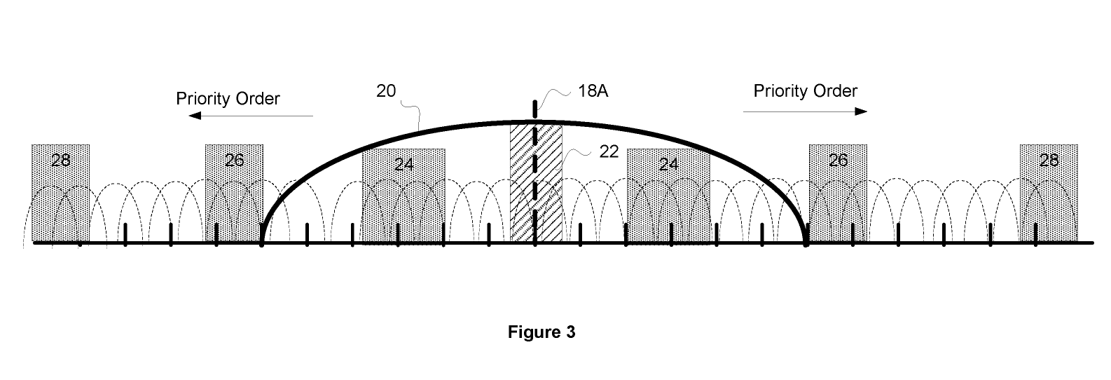

FIG. 3 illustrates one exemplary scheme for performing a non-contiguous priority order search emanating outwardly from a candidate for a wideband carrier's center 18A. As shown, the receiver 12 searching at least some possible narrowband allocations 24 that are closer in proximity to the one or more candidate wideband gridpoints 18A before searching at least some other possible narrowband allocations 26, 28 that are farther away in proximity to the one or more candidate wideband gridpoints 18A. In particular, the receiver 12 first searches possible narrowband allocations within block 24 that would lie in-band of a wideband carrier 20 with an assumed bandwidth (e.g., of 10 MHz) and that have a proximity between an inner threshold and an outer threshold (represented by the bounds of frequency block 24).

If this search does not confidently reveal the narrowband carrier, the receiver 12 then searches possible narrowband allocations within block 26 that have a proximity greater than a first assumed wideband edge threshold (represented here by the bandwidth of carrier 20), such that those allocations would lie adjacent to a wideband carrier 20 with the same or a different assumed bandwidth. That is, after failing to find the narrowband carrier within the most likely candidates for an in-band deployment, the receiver 12 skips over at searching at least some allocations between blocks 24 and 26 so as to search in a non-contiguous order, based on an assumption that the narrowband carrier instead lies adjacent to the wideband carrier 20 (e.g., within a guardband of the carrier 20).

Of course, the assumption about where to look in the frequency domain for the narrowband carrier at the edge of the wideband carrier must be coupled with an assumption about the bandwidth of the wideband carrier. In at least some embodiments, the receiver 12 performs successive searches based on different assumed bandwidths for the wideband carrier 20. For example, after failing to find the narrowband carrier within blocks 26, the receiver 12 may next perform a non-contiguous search based on assuming a different bandwidth for the wideband carrier 20. For instance, the receiver 12 searches possible narrowband allocations within blocks 28 that have a proximity greater than a second assumed wideband edge threshold such that those allocations would lie adjacent to a wideband carrier with a greater assumed bandwidth. In one or more embodiments, the receiver 12 likewise prioritizes the different possible bandwidths for the wideband carrier 20 (e.g., based on a likelihood of their being deployed, perhaps as informed by the receiver's location or other configuration). Armed with this bandwidth prioritization, the receiver 12 performs the successive searches with different assumed bandwidths, in the priority bandwidth order.

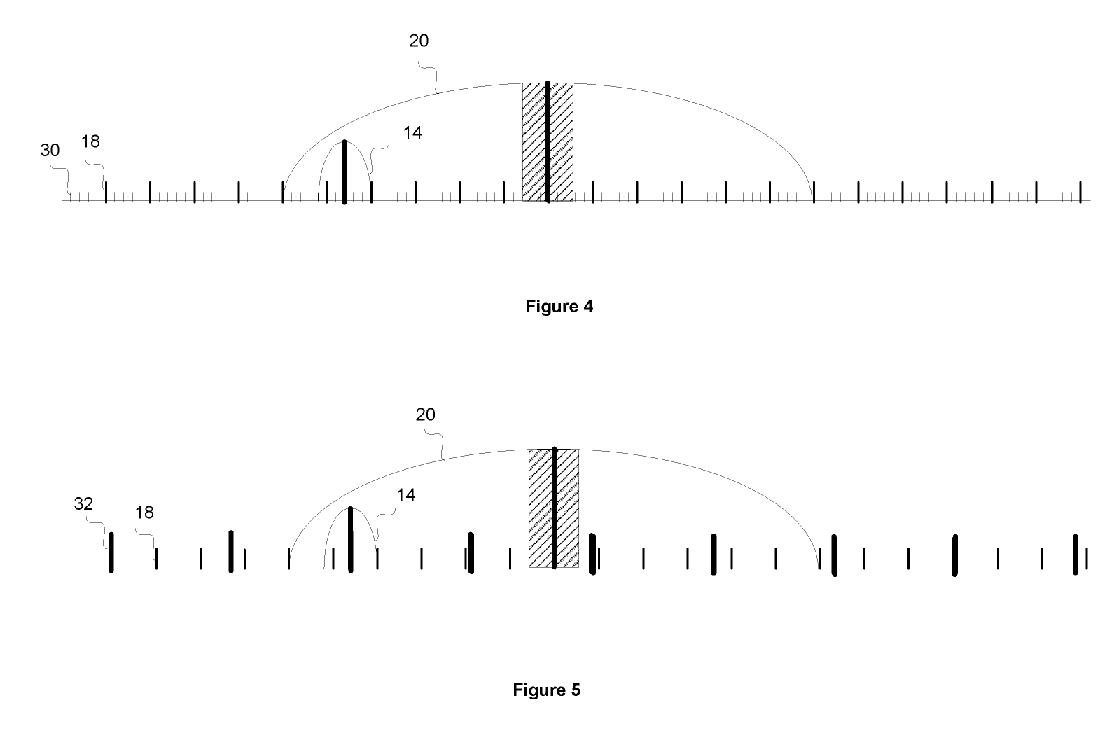

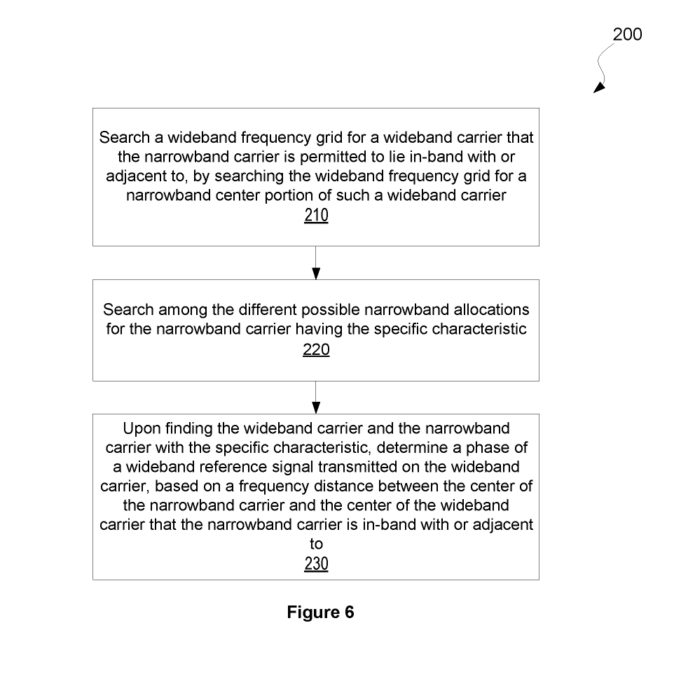

In at least some embodiments, the different possible narrowband allocations 16 comprise narrowband allocations centered on different possible narrowband gridpoints of a narrowband frequency grid that overlaps in frequency with the wideband frequency grid. FIGS. 4 and 5 illustrate different embodiments in this regard. FIG. 4 illustrates an embodiment where the receiver 12 employs a narrowband search grid (with narrowband gridpoints 30) that has a finer resolution (e.g., 20 kHz) than the wideband frequency grid (e.g., 100 kHz). FIG. 5 by contrast illustrates an embodiment where the receiver 12 employs a narrowband search grid (with narrowband gridpoints 32) that has a coarser resolution (e.g., 180 kHz) than the wideband frequency grid (e.g., 100 kHz).

In at least some embodiments, the receiver 12 dynamically adapts its narrowband search grid to have a different resolution. For example, in one embodiment, the receiver 12 upon finding a center frequency 18A of a wideband carrier 20, searches for the narrowband carrier using a coarser resolution search grid. In one NB-IoT embodiment, for instance, the receiver 12 uses a 180 kHz search grid for the narrowband carrier, and a 100 kHz search grid for the wideband carrier. Alternatively, the receiver 12 may use a 900 kHz search grid for the narrowband carrier (which is the least common multiple of the 180 kHz narrowband allocation resolution and the LTE 100 kHz search grid), while using a 100 kHz search grid for the wideband carrier. In any case, a subset of the narrowband grid points may align with the wideband gridpoints.

In one or more embodiments, the receiver 12 advantageously exploits the finding of both the wideband and narrowband carrier's centers to determine a phase of a wideband reference signal transmitted on the wideband carrier (e.g., a wideband cell-specific reference signal in LTE-based embodiments). That is, upon finding the narrowband carrier with the specific characteristic, the receiver 12 determines a phase of a wideband reference signal transmitted on the wideband carrier, based on a frequency distance between the center of the narrowband carrier and the center of the wideband carrier that the narrowband carrier is in-band with or adjacent to.

In one or more LTE-based embodiments, for example, the reference signal sequence is a cell-specific reference signal sequence described in 3GPP TS 36.211 v12.7.0 sections 6.10.1.1 and 6.10.1.2:

The reference-signal sequence r_{l,n}_{ₛ}(m) is defined by

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 2 {N}_{RB}^{max , DL} - 1 \qquad ( 1 )$$

where nₛ is the slot number within a radio frame and l is the OFDM symbol number within the slot. The pseudo-random sequence c(i) is defined in clause 7.2. The pseudo-random sequence generator shall be initialised with cᵢₙᵢₜ=2¹⁰·(7·(nₛ+1)+l+1)·(2·N_{ID}^{cell}+1)+2·N_{ID}^{cell}+N_{CP} at the start of each OFDM symbol where N_{ID}^{cell} is the cell identity number and

$${N}_{CP} = \{ \begin{matrix}1 & for normal CP \\ 0 & for extended CP\end{matrix} .$$

The reference signal sequence r_{l,n}_{ₛ}(m) shall be mapped to complex-valued modulation symbols a_{k,l}^{(p)} used as reference symbols for antenna port p in slot nₛ according to

a_{k,l}^{(p)}=r_{l,n}_{ₛ}(m′)

where

$$k = 6 m + ( v + {v}_{shift} ) mod 6$$

$$l = \{ \begin{matrix}0 , {N}_{symb}^{D} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL}$$

The variables v and v_{shift} define the position in the frequency domain for the different reference signals where v is given by

$$v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix}$$

The cell-specific frequency shift is given by v_{shift}=N_{ID}^{cell} mod 6.

For each PRB, there are two resource elements allocated to CRS for an antenna port on certain OFDM symbols.

PRB0, m=0 and m=1;

PRB1, m=2 and m=3;

Thus PRB number can be related to m index by m=2*PRB+j, j=0 or 1.

The m′ values are obtained using the m to m′ conversion expression above. Thus for each PRB the m′ values are used to get the CRS code phase according to equation (1).

The m to m′ conversion expression above may be rewritten as m′=m+N_max−N (some subscripts and superscripts are omitted here)

Note that N_max is the maximum number of PRBs allowed by LTE, which is known to all UEs and N is the number of PRB in the specific LTE carrier which is unknown to the UE.

N is related to the middle PRB number denoted by D (which has the DC subcarrier) by N=2*D

m′=m+N_max−N=2PRB+j+N_max−2D=2(PRB-D)+N_max.

Thus by knowing the PRB-D value, which is the offset of the NB-LTE PRB to the PRB with DC, the receiver 12 can figure out m′, the CRS code phase.

In one or more embodiments, the receiver 12 demodulates a broadcast channel (e.g., a physical broadcast channel PBCH) that is transmitted on the narrowband carrier and that includes system information, based on the determined phase of the wideband reference signal. This proves advantageous in that unique reference signals need not be used for demodulating such a broadcast channel. Moreover, the broadcast channel's system information (e.g., master information block, MIB) need not convey the frequency distance (i.e., offset) between the center of the narrowband carrier (e.g., NB IoT PRB) and the center of the wideband carrier that the narrowband carrier is in-band with or adjacent to. Indeed, in one or more embodiments, the system information includes information regarding a system frame number for the narrowband carrier but excludes information indicating the frequency distance between the center of the narrowband carrier and the center of the wideband carrier that the narrowband carrier is in-band with or adjacent to.

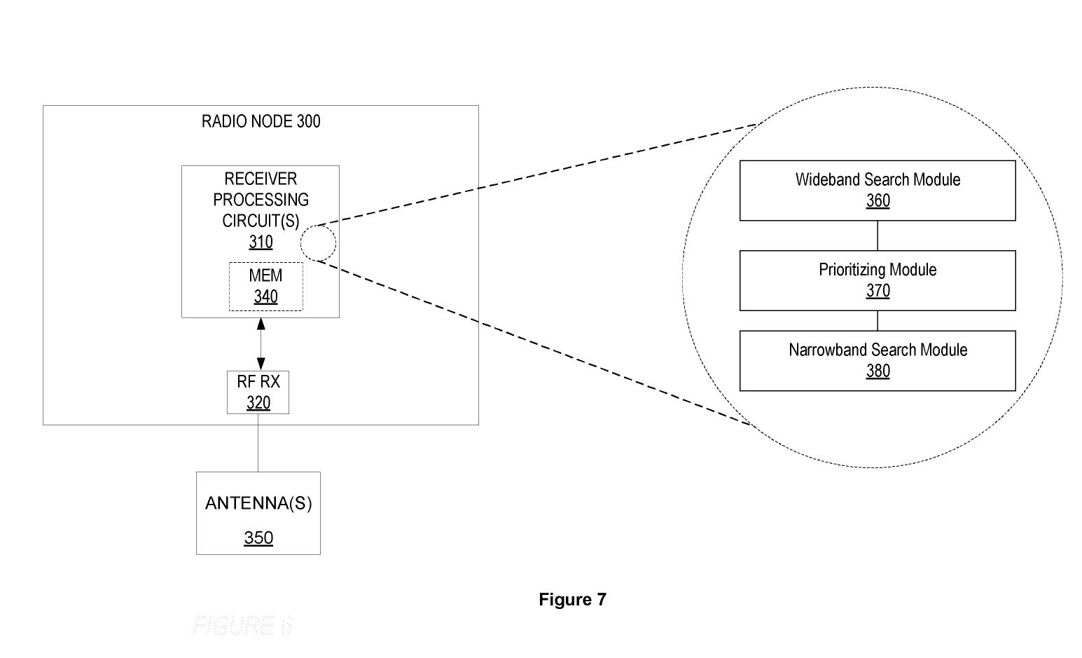

As an alternative or addition to embodiments above, a narrowband receiver may be configured to perform processing as shown in FIG. 6. As shown, the receiver 12 searches a wideband frequency grid for a wideband carrier that the narrowband carrier is permitted to lie in-band with or adjacent to, by searching the wideband frequency grid for a narrowband center portion of such a wideband carrier (Block 210). The receiver 12 further searches among the different possible narrowband allocations for the narrowband carrier having the specific characteristic (Block 220). In one or more embodiments, the receiver 12 need not necessarily prioritize the narrowband allocations as described above based on proximity to the wideband carrier's center portion. No matter how the narrowband carrier is found, therefore, the receiver 12 upon finding the wideband carrier and the narrowband carrier with the specific characteristic, determines a phase of a wideband reference signal transmitted on the wideband carrier, based on a frequency distance between the center of the narrowband carrier and the center of the wideband carrier that the narrowband carrier is in-band with or adjacent to (Block 130).

Similarly as explained above, the receiver may demodulate a broadcast channel that is transmitted on the narrowband carrier and that includes system information, based on the determined phase of the wideband reference signal. In at least one embodiment, the system information includes information regarding a system frame number for the narrowband carrier but excludes information indicating the frequency distance between the center of the narrowband carrier and the center of the wideband carrier that the narrowband carrier is in-band with or adjacent to.

In one or more embodiments, the specific characteristic comprises transmission of a set of one or more different possible known signal sequences, and searching comprises correlating a signal received in an allocation with the different possible known signal sequences to identify within which narrowband allocation said set of one or more signal sequences is transmitted. In one such embodiment, the different possible known signal sequences comprise one or more Constant Amplitude Zero Auto-Correlation (CAZAC) sequences. Alternatively or additionally, the different possible known signal sequences comprise one or more synchronization signal sequences (e.g., PSS and/or SSS in LTE-based embodiments).

In at least some embodiments, the receiver 12 is a direct-conversion receiver. A direct-conversion receiver (DCR), also known as a zero-IF or homodyne receiver, directly translates a received signal from a carrier frequency down towards baseband, without first translating to an intermediate frequency (IF) (i.e., in a single step). The simplicity of a DCR's architecture proves advantageous for numerous reasons. First, a DCR need not have bulky, off-chip, front-end image-reject filters, which are required in conventional super-heterodyne receivers that must reject signal images. Second, with the desired spectrum down-converted directly towards baseband, a DCR can perform channel selection with a simple analog low-pass filter or with digital-signal processing (DSP) after analog-to-digital conversion (ADC). Filtering at baseband means device parasitics are less severe, and less current is needed for amplification. Consequently, DCRs prove promising for low-cost and low-power applications.

In at least some embodiments, the receiver 10 is comprised within a radio node (e.g., a wireless communication device or a base station). In one or more embodiments, this radio node operates according to narrowband Internet of Things (NB-IoT) specifications.

In this regard, embodiments described herein are explained in the context of operating in or in association with a RAN that communicates over radio communication channels with wireless communication devices, also interchangeably referred to as wireless terminals or UEs, using a particular radio access technology. More specifically, embodiments are described in the context of the development of specifications for NB-IoT, particularly as it relates to the development of specifications for NB-IoT operation in spectrum and/or using equipment currently used by E-UTRAN, sometimes referred to as the Evolved UMTS Terrestrial Radio Access Network and widely known as the LTE system. However, it will be appreciated that the techniques may be applied to other wireless networks, as well as to successors of the E-UTRAN. Thus, references herein to signals using terminology from the 3GPP standards for LTE should be understood to apply more generally to signals having similar characteristics and/or purposes, in other networks.

A radio node, as described herein, can be any type of node capable of communicating with another node over radio signals. In the context of the present disclosure, it should be understood that a radio node may be a wireless device or a radio network node (e.g., a base station). A wireless device may refer to a machine-to-machine (M2M) device, a machine-type communications (MTC) device, and/or a NB-IoT device. The wireless device may also be a UE, however it should be noted that the UE does not necessarily have a “user” in the sense of an individual person owning and/or operating the device. A wireless device may also be referred to as a radio device, a radio communication device, a wireless terminal, or simply a terminal—unless the context indicates otherwise, the use of any of these terms is intended to include device-to-device UEs or devices, machine-type devices or devices capable of machine-to-machine communication, sensors equipped with a wireless device, wireless-enabled table computers, mobile terminals, smart phones, laptop-embedded equipped (LEE), laptop-mounted equipment (LME), USB dongles, wireless customer-premises equipment (CPE), etc. In the discussion herein, the terms machine-to-machine (M2M) device, machine-type communication (MTC) device, wireless sensor, and sensor may also be used. It should be understood that these devices may be UEs, but are generally configured to transmit and/or receive data without direct human interaction.

In an IOT scenario, a wireless device as described herein may be, or may be comprised in, a machine or device that performs monitoring or measurements, and transmits the results of such monitoring measurements to another device or a network. Particular examples of such machines are power meters, industrial machinery, or home or personal appliances, e.g. refrigerators, televisions, personal wearables such as watches etc. In other scenarios, a wireless device as described herein may be comprised in a vehicle and may perform monitoring and/or reporting of the vehicle's operational status or other functions associated with the vehicle.

In view of the above modifications and variations, those skilled in the art will appreciate that the receiver 12 illustrated in FIG. 1 may be configured to perform as described above by implementing any functional means or units. In one embodiment, for example, the receiver comprises respective circuits configured to perform the respective steps shown in FIGS. 2 and/or 6. The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more for carrying out one or more microprocessors, carries out the techniques described herein.

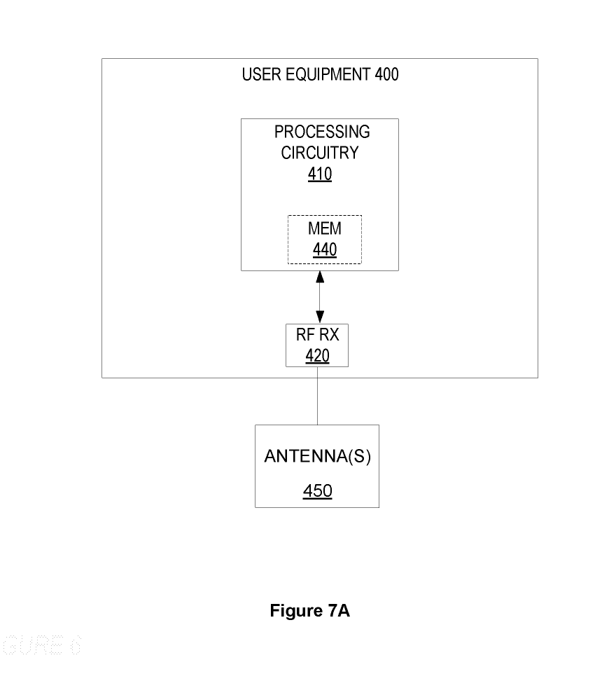

Embodiments herein also include a corresponding radio node that comprises receiver 12. FIG. 7 illustrates additional details of a radio node 300 in accordance with one or more embodiments. The radio node 300 is configured, e.g., via any functional means or units, to implement the receiver processing described above.

In at least some embodiments, the radio node 300 comprises one or more receiver processing circuit(s) 310 configured to implement the above processing, such as by implementing functional means or units (e.g., shown as a wideband search module 360, a prioritizing module 370, and a narrowband search module 380 configured to implement respective processing shown in FIG. 2). In one embodiment, for example, the receiver processing circuit(s) 310 implement functional means or units as respective circuits. The circuits in this regard may comprise circuits dedicated to performing certain functional processing and/or one or more microprocessors in conjunction with memory. In embodiments that employ memory 340, which may comprise one or several types of memory such as read-only memory (ROM), random-access memory, cache memory, flash memory devices, optical storage devices, etc., the memory stores program code that, when executed by the one or more for carrying out one or more microprocessors, carries out the techniques described herein. The radio node 300 in at least some embodiments further comprises an RF RX 320 configured to receive the received signal via one or more associated antennas 350.

Embodiments herein also include a corresponding user equipment (UE) that comprises receiver 12. FIG. 7A illustrates additional details of a user equipment 400 in accordance with one or more embodiments. The user equipment 400 is configured, e.g., via any functional means or units, to implement the methods described above.

In at least some embodiments, the user equipment 400 comprises processing circuitry 410 configured to implement the processing described above. In some examples, the narrowband receiver 12 described above may thus be implemented using processing circuitry 410. The circuitry in this regard may be circuitry dedicated to performing the above processing (e.g. an ASIC) and/or may comprise one or more microprocessors in conjunction with memory. In embodiments that employ memory 440, which may comprise one or several types of memory such as read-only memory (ROM), random-access memory, cache memory, flash memory devices, optical storage devices, etc., the memory stores program code that, when executed by the one or more for carrying out one or more microprocessors, carries out the techniques described herein. The user equipment 400 in at least some embodiments further comprises an RF RX 420 configured to receive the received signal via one or more associated antennas 450.

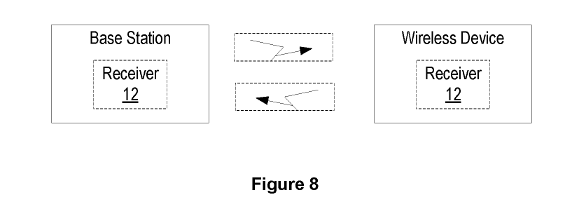

As shown in FIG. 8, in one embodiment, a radio node in the form of a wireless communication device (e.g., an M2M device) includes an embodiment of the receiver 12 as taught herein, for processing downlink signals transmitted by a base station. Additionally or alternatively, the base station includes an embodiment of the receiver 12 as taught herein, for processing uplink signals transmitted by the device, which may or may not be the same as the downlink channel.

Those skilled in the art will also appreciate that embodiments herein further include corresponding computer programs.

A computer program comprises instructions which, when executed on at least one processor of a mesh node, cause the node to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

Those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

1-43. (canceled)

44. A method implemented by a user equipment comprising a narrowband receiver for searching among different possible narrowband allocations for a narrowband carrier having a specific characteristic, the method comprising:
searching a wideband frequency grid for a narrowband portion of a wideband carrier that the narrowband carrier is permitted to lie in-band with or adjacent to, to obtain one or more candidate wideband gridpoints;
prioritizing one or more of the possible narrowband allocations based on their proximity to the one or more candidate wideband gridpoints; and
searching among the different possible narrowband allocations for the narrowband carrier having the specific characteristic, based on the specific characteristic and said prioritizing.

45. The method of claim 44, wherein searching the wideband frequency grid comprises searching for a narrowband center portion of a wideband carrier that the narrowband carrier is permitted to lie in-band with or adjacent to, to obtain one or more candidate wideband gridpoints that are candidates for the center of such a wideband carrier.

46. The method of claim 44, wherein searching the wideband frequency grid comprises searching for a narrowband center portion that has a null at its center.

47. The method of claim 44, wherein searching the wideband frequency grid comprises searching for any narrowband portion that has an energy profile characteristic of such a wideband carrier.

48. The method of claim 44, wherein said prioritizing comprises prioritizing at least some possible narrowband allocations that are closer in proximity to the one or more candidate wideband gridpoints above at least some other possible narrowband allocations that are farther away in proximity to the one or more candidate wideband gridpoints.

49. The method of claim 44, wherein said prioritizing comprises determining a priority order in which to search among the different possible narrowband allocations, based on the proximity of those allocations to the one or more candidate wideband gridpoints.

50. The method of claim 49, wherein searching according to the priority order comprises searching at least some possible narrowband allocations that are closer in proximity to the one or more candidate wideband gridpoints before searching at least some other possible narrowband allocations that are farther away in proximity to the one or more candidate wideband gridpoints.

51. The method of claim 49, wherein searching according to the priority order comprises first searching possible narrowband allocations that would lie in-band of a wideband carrier with an assumed bandwidth and that have a proximity between an inner threshold and an outer threshold, and then searching possible narrowband allocations that have a proximity greater than a first assumed wideband edge threshold such that those allocations would lie adjacent to a wideband carrier with the same or a different assumed bandwidth.

52. The method of claim 51, wherein searching according to the priority order next comprises searching possible narrowband allocations that have a proximity greater than a second assumed wideband edge threshold such that those allocations would lie adjacent to a wideband carrier with a greater assumed bandwidth.

53. The method of claim 44, wherein upon failure to find the narrowband carrier with the specific characteristic based on said searching, tentatively identifying the narrowband carrier as operating in a standalone configuration whereby the narrowband carrier does not lie in-band with or adjacent to such a wideband carrier, and continuing to search for the narrowband configuration based on said tentative identification.

54. The method of claim 44, wherein the different possible narrowband allocations comprise narrowband allocations centered on different possible narrowband gridpoints of a narrowband frequency grid that overlaps in frequency with the wideband frequency grid.

55. The method of claim 44, further comprising, upon finding the narrowband carrier with the specific characteristic, determining a phase of a wideband reference signal transmitted on the wideband carrier, based on a frequency distance between the center of the narrowband carrier and the center of the wideband carrier that the narrowband carrier is in-band with or adjacent to.

56. The method of claim 55, further comprising demodulating a broadcast channel that is transmitted on the narrowband carrier and that includes system information, based on the determined phase of the wideband reference signal.

57. The method of claim 56, wherein the system information includes information regarding a system frame number for the narrowband carrier but excludes information indicating the frequency distance between the center of the narrowband carrier and the center of the wideband carrier that the narrowband carrier is in-band with or adjacent to.

58. The method of claim 44, wherein the narrowband carrier is a narrowband Long Term Evolution (NB-LTE) carrier or narrowband Internet of Things (NB-IoT) carrier.

59. The method of claim 44, wherein the wideband carrier is an LTE carrier or a carrier that evolves from an LTE carrier.

60. The method of claim 44, wherein the narrowband receiver is a direct-conversion receiver.

61. The method of claim 44, wherein the specific characteristic comprises transmission of a set of one or more different possible known signal sequences, and wherein said searching comprises correlating a signal received in an allocation with the different possible known signal sequences to identify within which narrowband allocation said set of one or more signal sequences is transmitted.

62. A narrowband receiver for searching among different possible narrowband allocations for a narrowband carrier having a specific characteristic, the narrowband receiver comprising:
processing circuitry and a memory, the memory containing instructions executable by the processing circuitry whereby the narrowband receiver is configured to:
search a wideband frequency grid for a narrowband portion of a wideband carrier that the narrowband carrier is permitted to lie in-band with or adjacent to, to obtain one or more candidate wideband gridpoints;
prioritize one or more of the possible narrowband allocations based on their proximity to the one or more candidate wideband gridpoints; and
search among the different possible narrowband allocations for the narrowband carrier having the specific characteristic, based on the specific characteristic and said prioritizing.

63. The narrowband receiver of claim 62, configured to search the wideband frequency grid by searching for a narrowband center portion of a wideband carrier that the narrowband carrier is permitted to lie in-band with or adjacent to, to obtain one or more candidate wideband gridpoints that are candidates for the center of such a wideband carrier.

64. The narrowband receiver of claim 62, configured to search the wideband frequency grid by searching for a narrowband center portion that has a null at its center.

65. The narrowband receiver of claim 62, configured to search the wideband frequency grid by searching for any narrowband portion that has an energy profile characteristic of such a wideband carrier.

66. The narrowband receiver of claim 62, configured to prioritize at least some possible narrowband allocations that are closer in proximity to the one or more candidate wideband gridpoints above at least some other possible narrowband allocations that are farther away in proximity to the one or more candidate wideband gridpoints.

67. The narrowband receiver of claim 62, configured to prioritize one or more of the possible narrowband allocations by determining a priority order in which to search among the different possible narrowband allocations, based on the proximity of those allocations to the one or more candidate wideband gridpoints.

68. The narrowband receiver of claim 67, configured to search according to the priority order by searching at least some possible narrowband allocations that are closer in proximity to the one or more candidate wideband gridpoints before searching at least some other possible narrowband allocations that are farther away in proximity to the one or more candidate wideband gridpoints.

69. The narrowband receiver of claim 67, configured to search according to the priority order by first searching possible narrowband allocations that would lie in-band of a wideband carrier with an assumed bandwidth and that have a proximity between an inner threshold and an outer threshold, and then searching possible narrowband allocations that have a proximity greater than a first assumed wideband edge threshold such that those allocations would lie adjacent to a wideband carrier with the same or a different assumed bandwidth.

70. The narrowband receiver of claim 69, configured to search according to the priority order next by searching possible narrowband allocations that have a proximity greater than a second assumed wideband edge threshold such that those allocations would lie adjacent to a wideband carrier with a greater assumed bandwidth.

71. The narrowband receiver of claim 62, configured to, upon failure to find the narrowband carrier with the specific characteristic based on said searching, tentatively identify the narrowband carrier as operating in a standalone configuration whereby the narrowband carrier does not lie in-band with or adjacent to such a wideband carrier, and continue to search for the narrowband configuration based on said tentative identification.

72. The narrowband receiver of claim 62, wherein the different possible narrowband allocations comprise narrowband allocations centered on different possible narrowband gridpoints of a narrowband frequency grid that overlaps in frequency with the wideband frequency grid.

73. The narrowband receiver of claim 62, further configured to, upon finding the narrowband carrier with the specific characteristic, determine a phase of a wideband reference signal transmitted on the wideband carrier, based on a frequency distance between the center of the narrowband carrier and the center of the wideband carrier that the narrowband carrier is in-band with or adjacent to.

74. The narrowband receiver of claim 73, further configured to demodulate a broadcast channel that is transmitted on the narrowband carrier and that includes system information, based on the determined phase of the wideband reference signal.

75. The narrowband receiver of claim 74, wherein the system information includes information regarding a system frame number for the narrowband carrier but excludes information indicating the frequency distance between the center of the narrowband carrier and the center of the wideband carrier that the narrowband carrier is in-band with or adjacent to.

76. The narrowband receiver of claim 62, wherein the narrowband carrier is a narrowband Long Term Evolution (NB-LTE) carrier or narrowband Internet of Things (NB-IoT) carrier.

77. The narrowband receiver of claim 62, wherein the wideband carrier is an LTE carrier or a carrier that evolves from an LTE carrier.

78. The narrowband receiver of claim 62, wherein the narrowband receiver is a direct-conversion receiver.

79. The narrowband receiver of claim 62, wherein the specific characteristic comprises transmission of a set of one or more different possible known signal sequences, and wherein the narrowband receiver is configured to search the wideband frequency grid by correlating a signal received in an allocation with the different possible known signal sequences to identify within which narrowband allocation said set of one or more signal sequences is transmitted.

80. A computer readable storage medium containing a computer program comprising instructions which, when executed by at least one processor of a receiver, causes the receiver to search among different possible narrowband allocations for a narrowband carrier having a specific characteristic, wherein the instructions cause the receiver to:
search a wideband frequency grid for a narrowband portion of a wideband carrier that the narrowband carrier is permitted to lie in-band with or adjacent to, to obtain one or more candidate wideband gridpoints;
prioritize one or more of the possible narrowband allocations based on their proximity to the one or more candidate wideband gridpoints; and
search among the different possible narrowband allocations for the narrowband carrier having the specific characteristic, based on the specific characteristic and said prioritizing.
